(19) United States
(12) Patent Application Publication
(10) Pub. No.: US 2018/0276957 A1
(43) Pub. Date: Sep. 27, 2018

(54) Systems and Methods for Visual Representation of Social Interaction Preferences

(71) Applicant: Ahmed Ibrahim, Foster City, CA (US)

(72) Inventor: Ahmed Ibrahim, Foster City, CA (US)

(21) Appl. No.: 15/933,296

(22) Filed: Mar. 22, 2018

Related U.S. Application Data
(60) Provisional application No. 62/474,659, filed on Mar. 22, 2017.

(51) Int. Cl. G08B 5/36; G08B 1/08; G08B 21/18; H04R 1/10

(52) U.S. Cl. CPC G08B 5/36; H04R 1/10; G08B 21/18; G08B 1/08

(57) ABSTRACT

Users may control visual cues reflective of the user's social intentions and/or state of perception during use of personal electronic devices. In some embodiments, the visual cues may be provided by visual indicators on headphones, such as a multi-color LED, which change status based on the user's desired interactions with others. An LED embedded within an earphone may, for example, glow red when a user prefers not to be interrupted or when a user's device inhibits perception of external sounds, or glow green when a user is open to and available for interaction with others. The visual indicator status may be controlled manually by a user, or automatically. Visual cues may implement multiple discrete states, or may vary along a continuum of color and/or illumination level. A cloud server may track a user's visual cue state, for use in controlling or otherwise interacting with other network-connected services.

### TECHNICAL FIELD

The present disclosure relates in general to personal electronic devices, and in particular to devices interacting with users via production of electronic audio signals.

### BACKGROUND

With the proliferation of smartphones, tablets, laptop computers, wearable computing devices, and the like, electronic devices capable of playing music or other audio content have become ubiquitous. Users enjoy listening to audio content in a wide variety of locations, with some users listening to audio content nearly continually throughout the day. Use of electronic audio devices has become particularly popular via earphones/headphones, in public or group settings, such as coffee shops, while walking, or in office settings.

However, use of audio devices, particularly via headphones, may convey social messages that are unintended or undesired, and may limit or impair social interactions with others. For example, users wearing headphones may be perceived as unapproachable by others when in a public domain, thereby forcing users to choose between enjoying audio content and making themselves available for social interaction. Such binary choices may inhibit an individual's creativity or productivity. For example, some workplaces may impose a “no headphones at work” rule, presuming that everyone who wears headphones is unapproachable or purposefully declining interaction with others. However, such prohibitions preclude headphone use by other individuals, who may use music or other audio content to focus or be more productive, while still inviting interaction with others. In other circumstances, an individual may utilize a laptop PC in a bar or other public setting for casual entertainment purposes, while being receptive to social engagement with others. However, such laptop use may give rise to social connotations of business and unapproachability.

A user's intentions may also be confused in an opposite manner, such as when an uncommon device is used to carry out a high priority task. For example, in many social settings, there may be an assumption that mobile phone users are engaged in casual content consumption. If the user uses a mobile phone to engage in important work communications, e.g. while at a bar or restaurant, the user may be constantly interrupted as their approachability status is not understood.

Traditional headphones and other electronic devices may include visual cues of various sorts, but they generally reflect the operating state of the device itself, rather than the social intentions of the user. For example, a power light may illuminate to indicate a device's operability; and the light may flash or change color to indicate low battery level. However, such cues are not helpful in communicating the user's social intention and/or level of sensory perception to others. Lack of control over peer understanding of social intentions implied by use of personal electronic devices (such as approachability connotations) and the impact of personal electronic devices on a user's sensory perception, may cause many individuals to abstain from using a device in some circumstances, or to use devices in a non-optimal manner. Even worse, these effects may also impact or limit individuals' daily social interactions, promoting separation or disconnection from other individuals.

### SUMMARY

Systems and methods enable users to control visual cues to others that are reflective of the user's social intentions and/or sensory awareness during use of personal electronic devices. In some embodiments, the visual cues may be provided by visual indicators on headphones, such as a multi-color LED positioned to be visible to others during use, which change status based on the user's desired interactions with others, or based on how a device's mode of operation impacts the user's ability to perceive external sounds. An LED embedded within an earphone may, for example, glow red when a user prefers not to be interrupted, or glow green when a user is open to interaction with others. Additionally or alternatively, an LED embedded within an earphone may, for example, glow red when a user's personal electronic device is engaged in a mode of operation that significantly impairs the user's ability to hear external sounds (such as during an announcement, while playing audio at high volume), or glow greed otherwise. The visual indicator status may be controlled manually by a user, such as via toggling of a button or switch mounted on headphones, or via a user-configurable setting on a smartphone app interacting with the headphones. The visual indicator status may additionally or alternatively be controlled automatically, such as based on a headphone audio processing setting, the nature or source of audio content with which the user is engaging, or based on an active application operating on an associated electronic device such as a smartphone or laptop computer. The visual indicator may additionally or alternatively be external to the personal electronic device, such as a separate sign or display. Visual cues may implement multiple discrete states, or may vary along a continuum of color and/or illumination level. A cloud server may track a user's visual cue state, for use in controlling or otherwise interacting with other network-connected services.

### BRIEF DESCRIPTION OF THE DRAWINGS

FIG. 1 is a perspective view of an earphone, in accordance with one embodiment.

FIG. 2 is a schematic block diagram of an exemplary computing environment in which a visual cue may be implemented, including headphones, a personal electronic device and cloud server.

FIG. 3 is a visual cue state diagram.

FIG. 4 is a visual cue state diagram.

FIG. 5 is a visual cue state diagram, controlled by an application monitor.

FIG. 6 is a laptop computer implementing a visual cue.

FIG. 7 is a wireless earbud implementing a visual cue.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

Embodiments of the present invention are generally directed to personal electronic devices located on or around an individual's person during use, providing visual indication of a user's social state (such as their readiness for social interaction with others) or state of digital immersion (such as their ability to perceive external sounds or other stimuli).

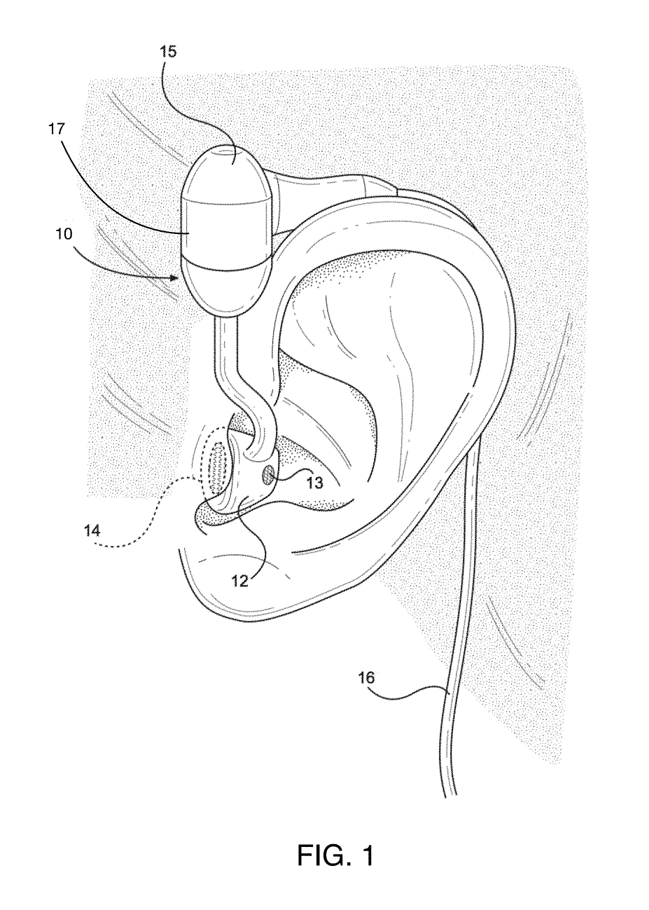

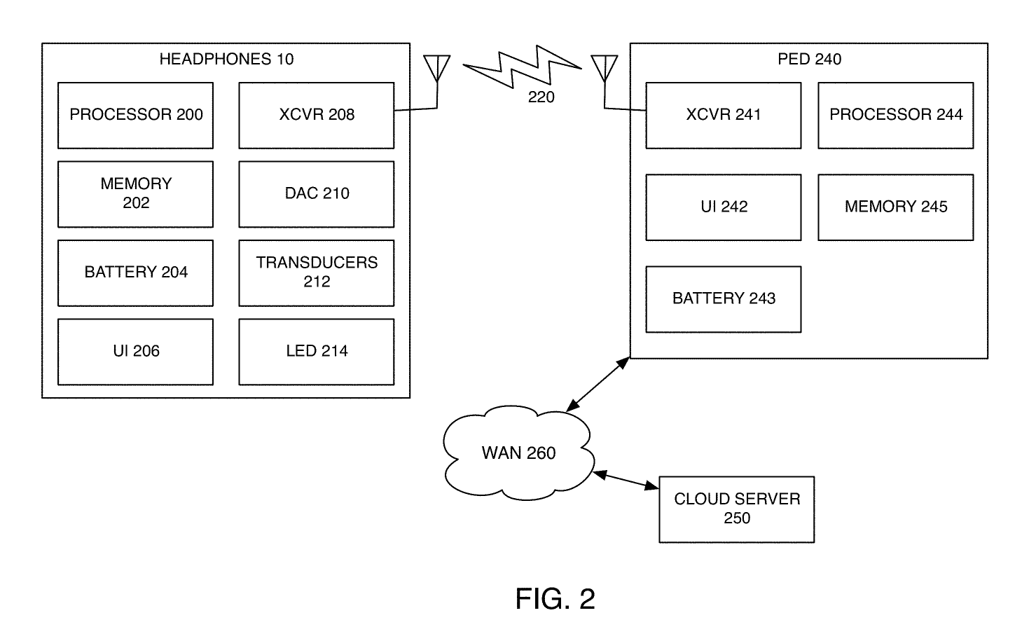

FIG. 1 illustrates an exemplary embodiment implemented in connection with wireless headphones. Earphones 10 include left earphone 10A, connected with a matching right earphone (not shown) via cord 16. Earphone 10A includes a portion 14 which fits into the user's ear, joined with an outer portion 15 which remains visible outside the user's ear. Indicator panel 17 is a translucent surface on outer portion 15, behind which a multicolor LED 214 is mounted (FIG. 2, described below). In operation, the illumination status and color of LED 214 may be varied, thereby controlling the appearance of indicator panel 17, which is visible to individuals proximate to the user of headphones 10.

FIG. 2 is a schematic block diagram of headphones 10, in operable communication with a personal electronic device 240 with which headphones 10 may be used. Headphones 10 include a microprocessor or microcontroller 200, and digital memory 202. Battery 204 provides power to onboard circuitry, enabling wireless use. User interface elements 206 permit direct, local interaction between a user and headphones 10 (and, in particular, application logic implemented on headphones 10 by processor 200 and memory 202). UI 206 may include, without limitation: buttons, switches, dials, touch-sensitive surfaces, voice control engines, optical sensors, and the like.

Wireless transceiver 208 enables digital communication between headphones 10 and other devices, such as personal electronic device 240. In some embodiments, transceiver 208 is a Bluetooth™ transceiver. Digital-to-audio converter 210 converts digital audio signals received by headphones 10 (e.g. via transceiver 208) into analog audio signals, which may then be applied to transducers 212 (which may include, without limitation, audio amplifiers and loudspeakers) to generate sound output.

Light emitting diode (“LED”) unit 214 is controlled by processor 200. In some embodiments, LED unit 214 is a multicolor LED unit capable of turning on and off, varying color and varying brightness. As is known in the art, LED unit 214 may include multiple light emitting diodes of different colors and/or brightnesses operating together to produce varying light output. In some embodiments, LED unit 214 will include multiple LED units operating together, such as one LED unit 214A mounted in a left earphone, and a second LED unit 214B mounted in a right earphone, such that one of LED units 214 may be visible to individuals proximate a wearer of headphones 10, regardless of their position relative to the wearer.

Headphones 10, and in particular transceiver 208, communicate via wireless communication link 220, with personal electronic device (“PED”) 240. In varying embodiments and use cases, PED 240 may be, without limitation: a smartphone, tablet computer, laptop computer, desktop computer, smart watch, smart glasses, other wearable computing devices, home assistant, smart home appliance, or smart television. Headphones 10 may also be utilized in conjunction with multiple PEDs.

PED 240 includes transceiver 241, which in some embodiments may be a Bluetooth transceiver adapted for bidirectional digital communications with headphones transceiver 208. PED 240 also includes user interface components 242, which may include a touch-sensitive display screen. Battery 243 provides power to PED 240 during portable use. Microprocessor 244 implements application logic stored within memory 245, and otherwise controls the operation of PED 240.

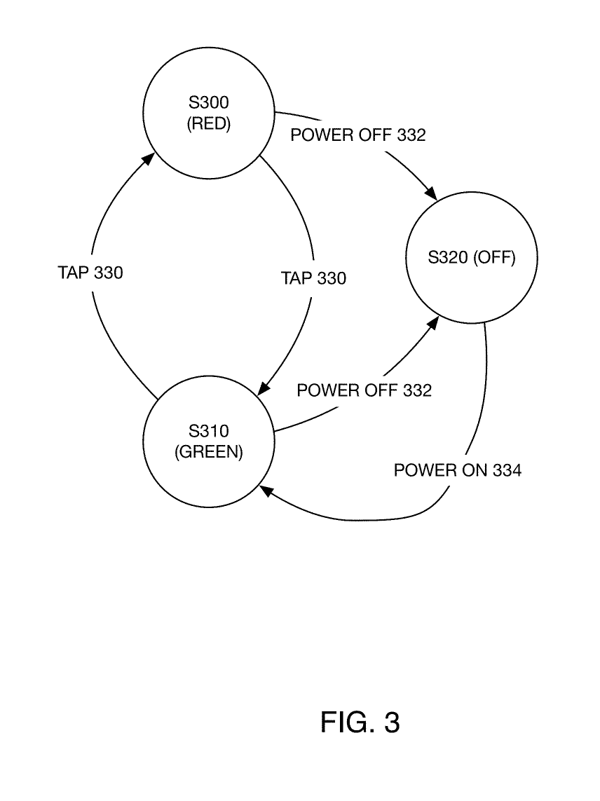

FIG. 3 is a state diagram of an exemplary mode of operation that may be implemented by headphones 10, providing a user with manual control over a social availability visual indicator. In the embodiment of FIG. 3, state S300 represents a condition in which LED 214 is illuminated in the color red, to indicate to nearby individuals that the user of headphones 10 is in a state where social interaction is discouraged. State S310 represents a state in which LED 214 is illuminated green, to indicate to nearby individuals that the user of headphones 10 is in a state where social interaction is welcomed. State S320 represents a state in which LED 214 is not illuminated. Headphones user interface components 206 include devices for detecting tapping user interactions, whereby a user taps one of earphone external bodies 15. Suitable components may include, inter alia, an accelerometer to detect motion of body 15 in response to a tap, or capacitive touch sensors.

In operation, a user may engage in tapping action 330 to transition between red S300 and green S310 illuminated states. From either state S300 or S310, headphone UI components 206 may be used to power down the headphones (action 332, e.g. long press on a power button), thereby transitioning LEDs 214 to an unilluminated state S320. From state S320, headphones 10 may be powered on (action 334, e.g. long press on a power button) to transition to green state S310.

Thus, the visual cue illumination status is changed by actuation of a trigger. In the embodiment of FIG. 3, triggers include tapping on an earphone body, powering down, or powering up. However, it is contemplated and understood that other events may be beneficially utilized as triggers, to transition the visual cue between states. Other triggers may include one or more of: pressing a button on headphones 10; inserting or removing headphone 10 from a user's ear (which may be detected by, e.g., change in light level detected by an inwardly-facing optic sensor on internal headphone component 14); or receipt by transceiver 208 of a control signal, such as may be transmitted by an application operating on PED 240.

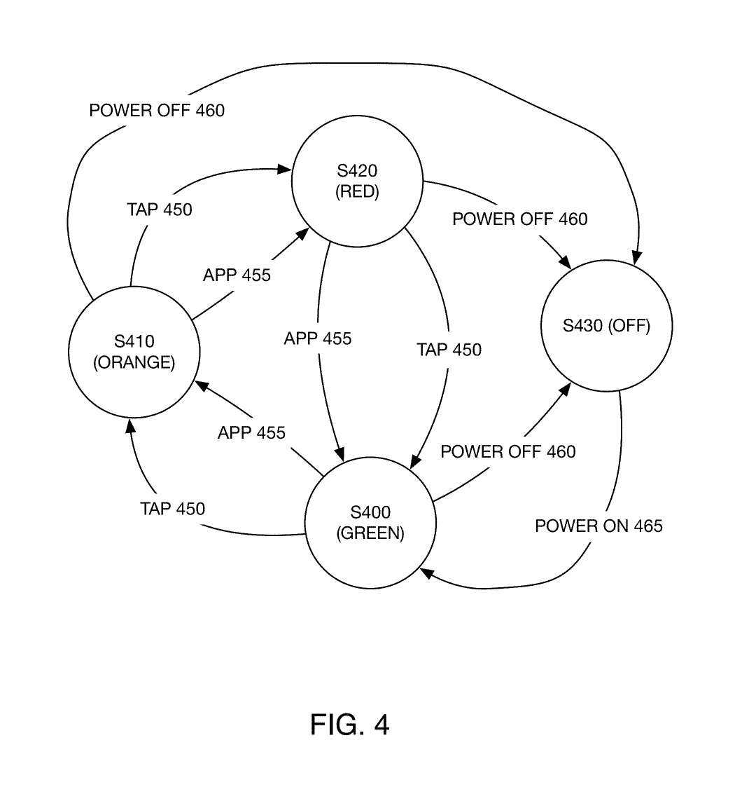

FIG. 4 is a state diagram illustrating another embodiment, in which the visual cue may be controlled based at least in part on a user's acoustical awareness of their surroundings. In the embodiment of FIG. 4, headphones 10 are noise cancelling headphones having multiple audio modes. Such modes may include: a “hear through” mode in which ambient sound is reproduced by the headphone with little masking or attenuation; a “modified” mode in which components of ambient sounds may be masked or attenuated as perceived by the wearer of headphones 10; and a full noise cancelling or noise blocking mode of operation in which ambient sounds are cancelled out or heavily attenuated, as perceived by the wearer of headphones 10. The visual cue in the embodiment of FIG. 4, provided by LED 214, has three illuminated states (GREEN state S400, ORANGE state S410 and RED state S420), and an unilluminated state S430.

Each of the illuminated states corresponds to a different audio mode of headphones 10. Thus, when headphones 10 are initially powered on (action 465), they occupy a “hear through” mode of operation, and LED 214 is placed in GREEN state S400 by processor 200. The user may toggle the headphones to a modified mode of operation, such that processor 200 transitions LED 214 to ORANGE state S410. The state toggling may be implemented locally by a tap action 450, or remotely via use of PED 240, such as a control signal generated by a PED app and conveyed by transceiver 241 to transceiver 206 (app control signal 455). Similarly, from ORANGE state S410, tap action 450 or app control signal 455 may be used to transition to RED state S420. In turn, tap action 450 or app control signal 455 may then be used to transition back to GREEN state S400. From any of states S400, S410 or S420, a POWER OFF action may be used to transition to unilluminated state S430.

In some embodiments, an audio modification profile implemented by headphones 10 may be optimized for a desired level of interaction with others. For example, a “conversation mode” may provide not only play-through of ambient sounds, but equalization of exterior ambient sounds to maximize clarity of audio content commonly found in human speech, while simultaneously attenuating music or other audio content being played back to ensure the sound level, and/or the distribution of audio playback content over the frequency spectrum, do not prevent effective conversation. Such a conversation mode may be associated with a GREEN visual cue, thereby encouraging the types of interaction for which the audio modification profile is best suited. Similarly, an “office” mode of operation may apply audio signal processing to allow a wearer to perceive nearby human speech with limited attenuation, while masking distant sounds, frequencies outside the primary range of human speed, and other typical office noises. Such an office mode may be associated with an ORANGE visual cue, indicating to others the user's intent for productivity, while conveying receptiveness to important communications. A “focus” mode of operation may apply full noise cancellation functions to minimize the user's perception of outside sounds, while playing through music or other audio content without attenuation. Such a “focus” mode may be associated with a RED visual cue, thereby indicating to others that the wearer is fully engaged and desires minimum interruption. By coupling a visual indication of a user's intent with an associated mode of audio processing, misunderstandings may be avoided, such as where a co-worker believes they are being ignored when, in fact, headphone noise cancellation prevents the wearer from perceiving attempted communications.

While the exemplary embodiment of headphones 10 is illustrated in the context of wireless headphones, it is contemplated and understood that other embodiments may be implemented in a wired headphones application.

In some embodiments, visual cues as described herein may be implemented by means other than an LED. For example, LCD or other light emitting displays may be used. Non-light emitting indicators may be used, such as e-ink displays. In some embodiments, a device may include components (such as a portion of a device casing) which are capable of adaptively changing colors (e.g. electrochromic materials, or magnetochromic materials) to indicate status as described herein. These and other mechanisms for indicating a user's availability for social interaction may be provided.

In some embodiments, devices other than headphones may include visual cues. For example, a smartphone case may include a battery, which may be used to extend the power reserve for a smartphone, but which may also power circuitry analogous to aspects of headphones 10 (such as a microprocessor, transceiver, UI, and a visual indicator such as an LED or LCD) to provide a visual cue while an individual is utilizing the smartphone. In other embodiments, a visual cue may be incorporated into an article of clothing or jewelry, such as a button or fabric clothing with electrochromic printing. In such embodiments, at some level, a control circuit will vary the state of a visual indicator (or proxy therefor) based on application logic as described herein.

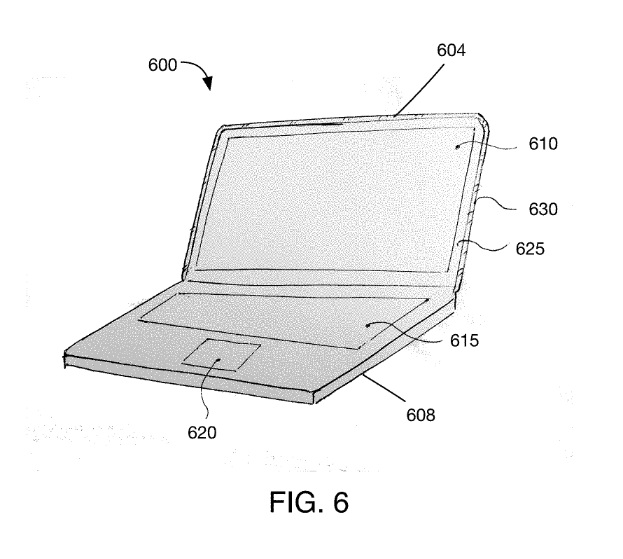

In another embodiment, a laptop computer may implement a visual cue by varying the color of a display border, or varying the color of a logo displayed on the backside of a laptop screen. FIG. 6 illustrates an exemplary laptop computer embodiment. Laptop computer 600 includes display unit 604 and base unit 608, in a clamshell configuration. Base unit 608 includes keyboard 615 and track pad 620. Display unit 604 includes display screen 610, surrounded by inner screen bezel 625. Bezel 625 is a conventional screen bezel, e.g. such as may be used to conceal periphery hardware associated with operation of display screen 610. Display unit 604 also includes indicator border 630, which may be formed from, for example, a translucent panel backlit by a multicolor LED, circumscribing the periphery of laptop computer display unit 604. In such an embodiment, laptop computer 600 may implement function and structure analogous to PED 240 in the embodiment of FIG. 2, directly integrated with indicator border 630 as an analog to indicator LED 214, controlled directly by control circuitry within laptop 600.

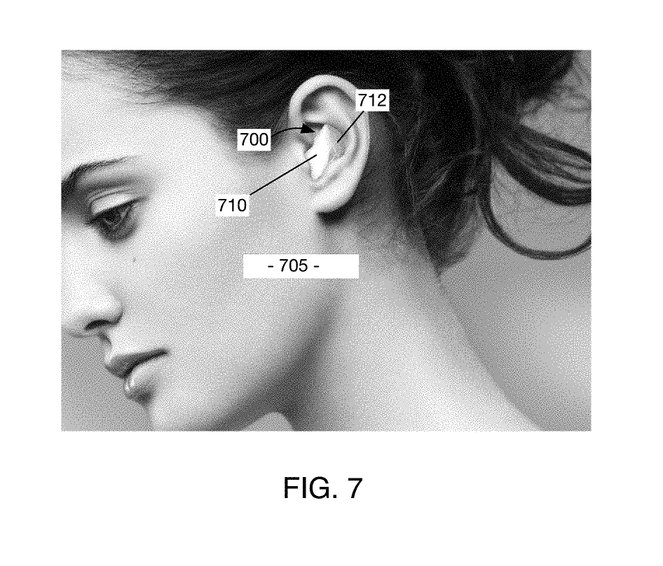

In another headphone embodiment, the color of all or some portion of the headphone body itself may change appearance to indicate a visual cue. One such embodiment is illustrated in FIG. 7. The embodiment of FIG. 7 includes left wireless earbud 700, and a matching right wireless earbud (not shown), both of which are shaped for insertion into the ear opening of a user 705. Earbud 700 is formed from a casing shell having a first portion 710 and a second portion 712. Second casing portion 712 is formed from a translucent material, such as a translucent plastic, and backlit by a color or multicolor LED, analogous to LED 214 in the embodiment of FIG. 2. The color and illumination state of casing portion 712 varies to provide a visual cue of the user's status, such as readiness for social engagement, as described hereinthroughout.

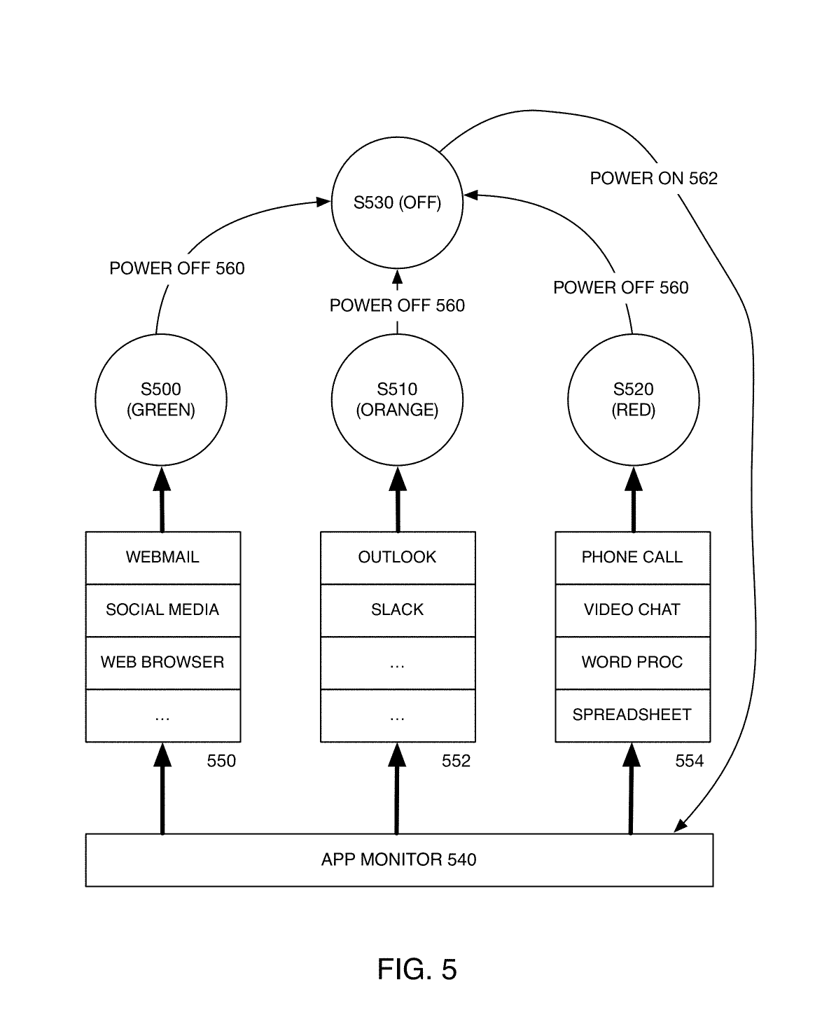

In some embodiments, an application state on one device, such as PED 240, may be used to control a visual cue on the same or different device, such as headphones 10. FIG. 5 illustrates a state diagram for such an embodiment. States S500 (GREEN), S510 (ORANGE), S520 (RED) and S530 (UNILLUMINATED) are analogous to visual cue states S400, S410, S420 and S430, described above. PED 240 executes an application monitor applet or service 540 in the background, which identifies the application presently operating in the foreground of PED 240. Application monitor 540 references application tables 550, 552 and 554 to determine whether the foreground application has been associated by the user with a particular visual cue state. Preferably, application tables 550, 552 and 554 are configurable by the user. Table 550 lists applications for which a GREEN visual cue is desired, e.g. applications for which a user invites interaction with others during use. Table 552 lists applications for which an ORANGE visual cue is desired, e.g. applications for which a user is neutral with regard to interaction with others during use, such as “light” work applications. Table 554 lists applications for which a RED visual cue is desired, e.g. applications for which a user desires to discourage interaction with others, such as intense work applications or applications for which a user's full concentration is otherwise typically required. If application monitor 540 identifies the foreground application within table 550, a control command is transmitted to the visual cue apparatus (e.g. LED 214) to transition to GREEN state S500. If application monitor 540 identifies a foreground application within table 552, a control command is transmitted to the visual cue apparatus (e.g. LED 214) to transition to ORANGE state S510. If application monitor 540 identifies a foreground application within table 554, a control command is transmitted to the visual cue apparatus (e.g. LED 214) to transition to RED state S520. As in other illustrated embodiments, the visual cue may be turned off from any state (e.g. by action 560). When powered on (e.g. via action 562), state control returns to application monitor 540. If the visual cue is integrated directly within the electronic device (e.g. an illuminated indicator within PED 240), application monitor 540 may apply state change controls directly to the visual cue. If the visual cue is integrated into a remote device (such as headphones 10), application monitor 540 may act to transmit a control command to the remote device (e.g. via transceivers 241 and 208) to change the state of the visual cue (e.g. LED 214, under control of processor 200).

In some embodiments, rather than having a visual cue state determined by a single criterion, numerous factors may be evaluated to determine a visual cue state. For example, a visual cue on headphones may be set to a RED state at all times during which full noise cancelling functions are active. However, when full noise cancelling functions are not active, the visual cue state may be dependent upon a remote device application monitoring function, such as that of FIG. 5. Factors utilized to determine visual cue state may include numerous factors, potentially including (without limitation) manual selection, aspects of headphone operation, and aspects of operation for one or multiple remote electronic devices in communication with the headphones or other device on which the visual cue is implemented. Evaluation of such factors may be performed in the device implementing the visual cue (e.g. headphones 10 via processor 200), or on a remote device transmitting control signals to the visual cue device (e.g. PED 240 via processor 244).

In some embodiments, rather than providing a limited number of discrete states for a visual cue (e.g. red, orange, green), a visual cue state may be represented along a continuum. For example, a visual cue may transition in a color continuum, from red to green. In other embodiments, a visual cue may transition in illumination intensity (e.g. very bright red indicating maximal discouragement of interaction, with multiple states of lesser illumination indicating progressively less discouragement of interaction). Continuum-based embodiments may be particularly effective when a large number of factors are used in a weighted determination of visual cue state.

In some embodiments, a user's visual cue or accessibility status may be reported to a cloud service, which may be used for controlling other network-based services. For example, in FIG. 2, PED 240 may report the state of a user's visual cue to cloud server 250 via wide area network 260, which may include a cellular data network and/or the Internet. Cloud server 250 may then provide an API accessible to diverse cloud services for determining a user's desired level of outside interaction. For example, a social networking service may poll cloud server 250 before transmitting notifications to PED 240, with notifications being delayed while a user is in a RED “focus” mode of operation. Alternatively, an augmented reality or mixed reality application may poll cloud server 250 to determine another individual's visual cue state, and then apply a visual augmentation to the individual based on their state; for example, augmented reality glasses or goggles may render another individual with a RED, ORANGE or GREEN indicator proximate the individual, based on the individual's visual indicator state as queried from cloud server 250. These and other application interactions can be implemented by making user state available remotely via cloud server 250.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or any appended claims.

1. An indicator for visually conveying information concerning the availability for interaction with others of a user of a personal electronic device, comprising:
a visual indicator having a plurality of visually-differentiable states, the visual indicator positioned proximate the user and oriented for visibility to other individuals in the user's vicinity; and
a controller operable to switch the visual indicator between said plurality of visually-differentiable states.
